(19) United States
(12) Patent Application Publication
(10) Pub. No.: US 2026/0355915 A1
(43) Pub. Date: Nov. 12, 2026

(54) Tool Assembly

(71) Applicant: Chang-Yu Tsai, City (TW)

(72) Inventor: Chang-Yu Tsai, City (TW)

(21) Appl. No.: 19/199,550

(22) Filed: May 6, 2025

(51) Int. Cl. B25B 23/00; B25B 15/00; B25G 1/08

(52) U.S. Cl. CPC B25B 23/0028; B25B 15/008; B25G 1/085

(57) ABSTRACT

A tool assembly includes a first body, wo control units, multiple rotational members, multiple hand tools, and two second body units. The first body has two first pivot portions, multiple receiving spaces, two control chambers, a first opening, and a second opening. Each of the rotational members is rotatable in each of the receiving spaces. Each of the rotational members is provided with a third pivot portion, multiple second locking portions, and a receiving groove. Each of the hand tools is mounted on each of the rotational members. Each of the two control units is movable linearly in one of the two control chambers and controls the rotational members and the hand tools to move relative to the first body between a locked state and an unlocked state. The two second body units are mounted outside of the first body.

### BACKGROUND OF THE INVENTION

### Field of the Invention

The present invention relates to a tool assembly and, more particularly, to a foldable tool assembly.

### Description of the Related Art

A conventional tool assembly or lockable folding multi-tool was disclosed in the U.S. Patent No. US8,490,523, and comprises a separator 60, a grip material 25, multiple lock engaging members 81, multiple work tools 32, two supports 50, two lock members 90, and two push buttons 100. Each of the lock members 90 has multiple circumferential grooves 92 for receiving the work tools 32.

However, the conventional tool assembly has the following disadvantages.
1. With reference to FIG. 7, each of the lock members 90 has a cylindrical shape and is movable on the separator 60 to lock or unlock lock engaging members 81 and the work tools 32. The work tools 32 have different specifications and different width so that different spacings are defined between the work tools 32. The circumferential grooves 92 have to fit the width of the work tools 32 so that the circumferential grooves 92 have different spacings. Thus, the circumferential grooves 92 are worked to have different positions to correspond to the work tools 32, thereby complicating the working process. In addition, each of the lock members 90 has to be worked for forming the circumferential grooves 92. But, the separator 60 has a small volume, thereby limiting the diameter of each of the lock members 90, and thereby further limiting the diameter of each of the circumferential grooves 92. Thus, the strength of each of the circumferential grooves 92 is limited so that each of the circumferential grooves 92 is easily broken during a long-term utilization.
2. The grip material 25 need to form the first opening 102 for receiving the two push buttons 100. Each of the two push buttons 100 needs to form a flange to prevent the two push buttons 100 from being detached from the grip material 25. Thus, it is necessary to provide the two push buttons 100 and the lock members 90, thereby complicating the fabrication.
3. The two lock members 90 are pressed on the separator 60 to lock or unlock the work tools 32. At this time, the two lock members 90 are pressed from a single side of the separator 60 and cannot be pressed from two sides of the separator 60. Thus, when the user holds the tool assembly in a different direction, the user's finger cannot touch the two lock members 90 so that it is necessary to turn the separator 60 to facilitate the user pressing the two lock members 90, thereby causing inconvenience to the user.
4. With reference to FIG. 2, the positions of the circumferential grooves 92 have to fit the work tools 32 mounted in the separator 60, so that the circumferential grooves 92 of the two lock members 90 have different positions. Thus, the conventional tool assembly has two lock members 90 that have different spacings for fitting the work tools 32 of different spacings, so that when one of the work tools 32 has to be replaced, it is necessary to replace a respective one of the two lock members 90.

A conventional tool locking mechanism was disclosed in the U.S. Patent No. US6,868,760, and comprises a housing 12, two shafts 28, and multiple tools 60. Each of the two shafts 28 is moved axially on the housing 12 to control the tools 60 so that the tools 60 are locked or unlocked.

### BRIEF SUMMARY OF THE INVENTION

In accordance with the present invention, there is provided a tool assembly comprising a first body, two control units, multiple rotational members, multiple hand tools, two second body units, and two fastening members. The first body has two first pivot portions, multiple receiving spaces, two control chambers, a first opening, and a second opening. Each of the two control units is movable in one of the two control chambers. Each of the rotational members is pivotally mounted in each of the receiving spaces and is rotatable in each of the receiving spaces. Each of the rotational members is provided with a third pivot portion, multiple second locking portions, and a receiving groove. Each of the hand tools is mounted on each of the rotational members. Each of the two control units is movable linearly in one of the two control chambers and controls the rotational members and the hand tools to move relative to the first body between a locked state and an unlocked state. The two second body units are mounted outside of the first body, with one of the two second body units limiting the two control units to prevent the two control units from being detached from the two control chambers

According to the primary advantage of the present invention, each of the rotational members and each of the hand tools are rotatable in the first body. The operation end of each of the hand tools may be folded and stored in the first body and has a locking effect. When the locked state is unlocked by the user, each of the hand tools is rotated so that the operation end of each of the hand tools is exposed from the first body to facilitate the user operating the hand tools. Thus, the hand tools are operated, stored, and carried easily and conveniently.

According to another advantage of the present invention, the support portion has a lump shape, and each of the passages is a cavity. Thus, each of the passages has a better structural support, so that the control block has a better structural strength and is not broken easily.

According to a further advantage of the present invention, the control part is provided with the first locking sections and the passages. The first locking sections and the passages are supported by the support portion, so that the first locking sections and the second locking portions are locked exactly to secure the locked state. When one of the passages aligns with one of the second locking portions, the locked state is unlocked, so that the rotational members and the hand tools can be rotated freely relative to the first body.

According to a further advantage of the present invention, the two second body units are mounted outside of the first body, with one of the two second body units limiting the two control units to prevent the two control units from being detached from the two control chambers. Each of the two control units is used to lock or unlock the rotational members and the hand tools, so that only a single element is needed to perform the locking or unlocking function.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is an exploded perspective view of a tool assembly in accordance with the preferred embodiment of the present invention.

FIG. 2 is a perspective view of a first body of the tool assembly in accordance with the preferred embodiment of the present invention.

FIG. 3 is another perspective view of the first body of the tool assembly in accordance with the preferred embodiment of the present invention.

FIG. 4 is an exploded perspective view of a control unit of the tool assembly in accordance with the preferred embodiment of the present invention.

FIG. 5 is a top view of a control block of the tool assembly in accordance with the preferred embodiment of the present invention.

FIG. 6 is a perspective view showing multiple rotational members and multiple hand tools of the tool assembly in accordance with the preferred embodiment of the present invention.

FIG. 7 is an exploded perspective view of a second body unit of the tool assembly in accordance with the preferred embodiment of the present invention.

FIG. 8 is a partial perspective view of the tool assembly in accordance with the preferred embodiment of the present invention.

FIG. 9 is a perspective view of the tool assembly in accordance with the preferred embodiment of the present invention.

FIG. 10 is a top view of the tool assembly as shown in FIG. 9.

FIG. 11 is a top view showing a first operational state of the tool assembly in accordance with the preferred embodiment of the present invention.

FIG. 12 is a locally enlarged view of the tool assembly taken along circle A as shown in FIG. 11.

FIG. 13 is a perspective view showing a second operational state of the tool assembly in accordance with the preferred embodiment of the present invention.

FIG. 14 is an exploded perspective view of a control unit of the tool assembly in accordance with the second preferred embodiment of the present invention.

FIG. 15 is a top view of a control block of the tool assembly in accordance with the second preferred embodiment of the present invention.

FIG. 16 is a partial top view of the tool assembly in accordance with the second preferred embodiment of the present invention.

FIG. 17 is a top view showing an operational state of the tool assembly in accordance with the second preferred embodiment of the present invention.

FIG. 18 is a locally enlarged view of the tool assembly taken along circle A as shown in FIG. 17.

### DETAILED DESCRIPTION OF THE INVENTION

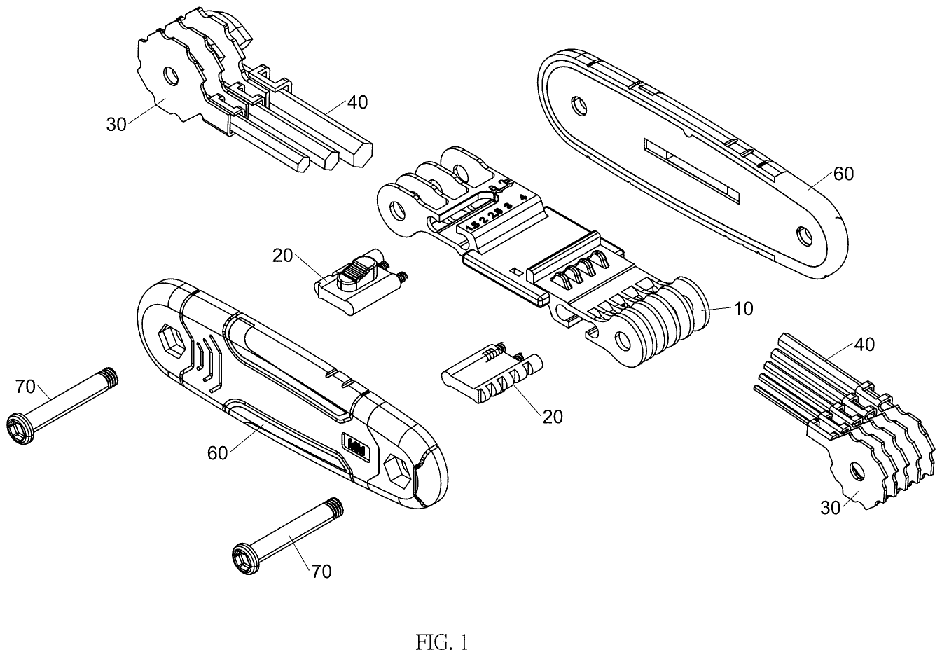

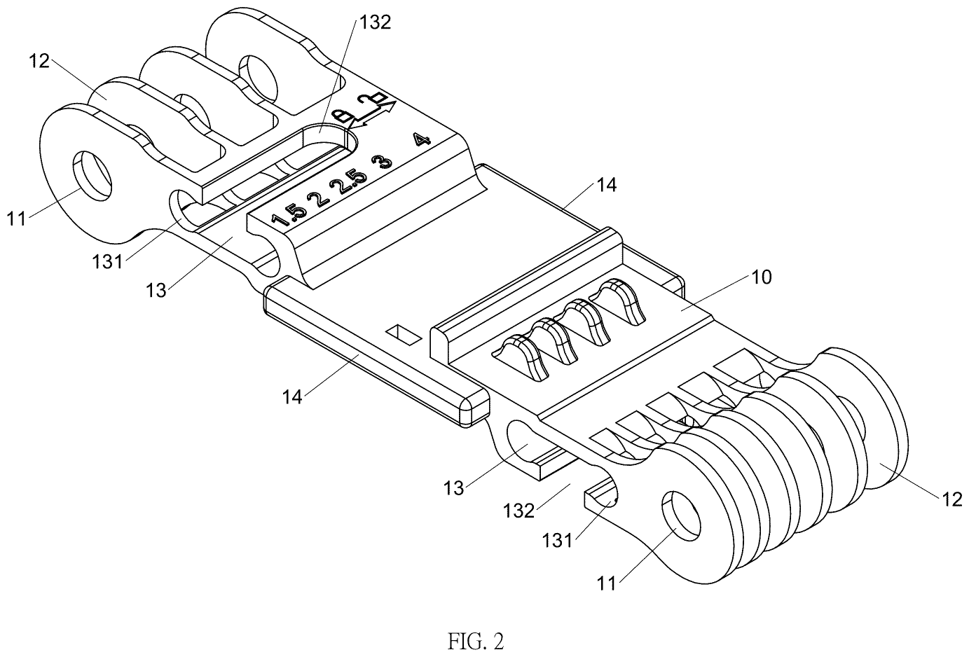

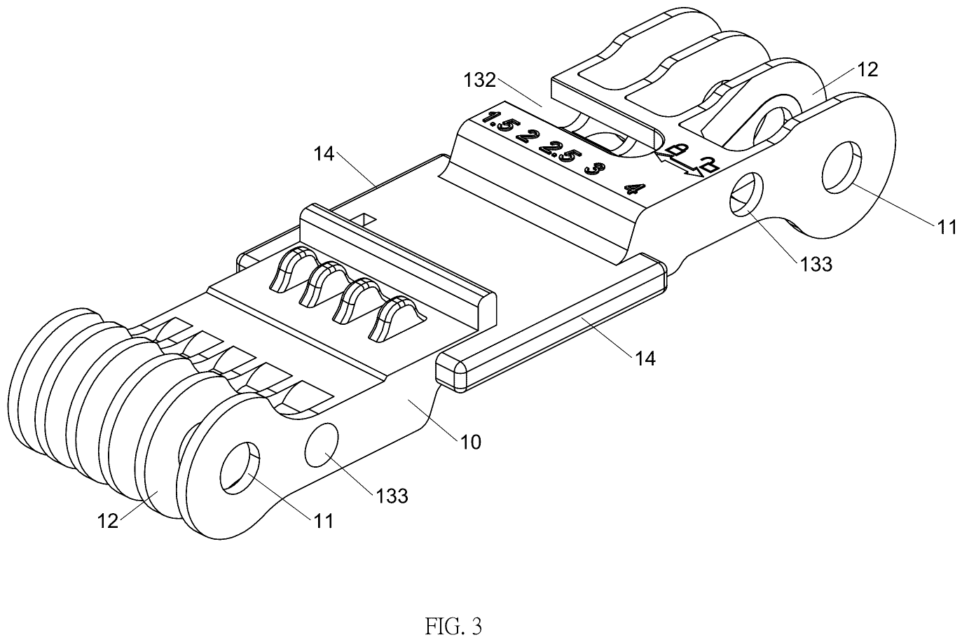

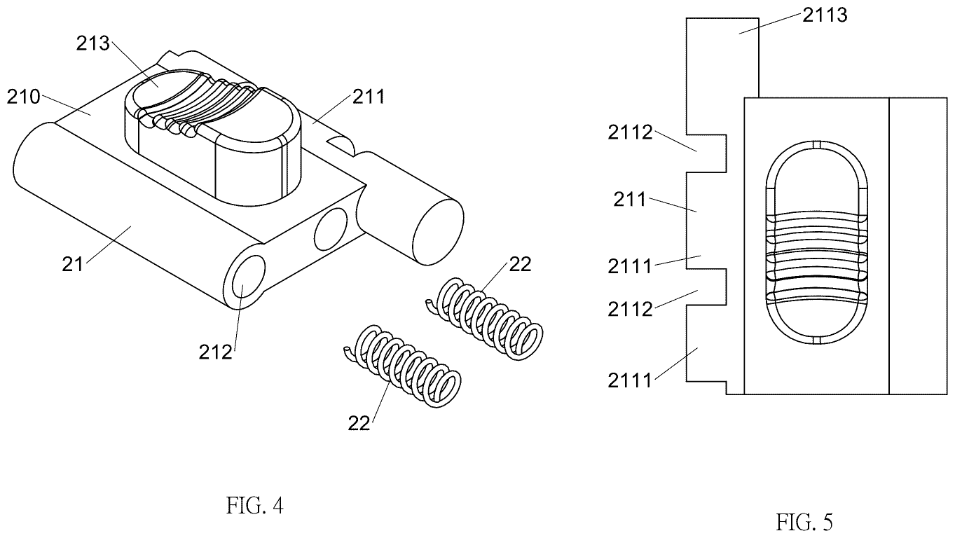

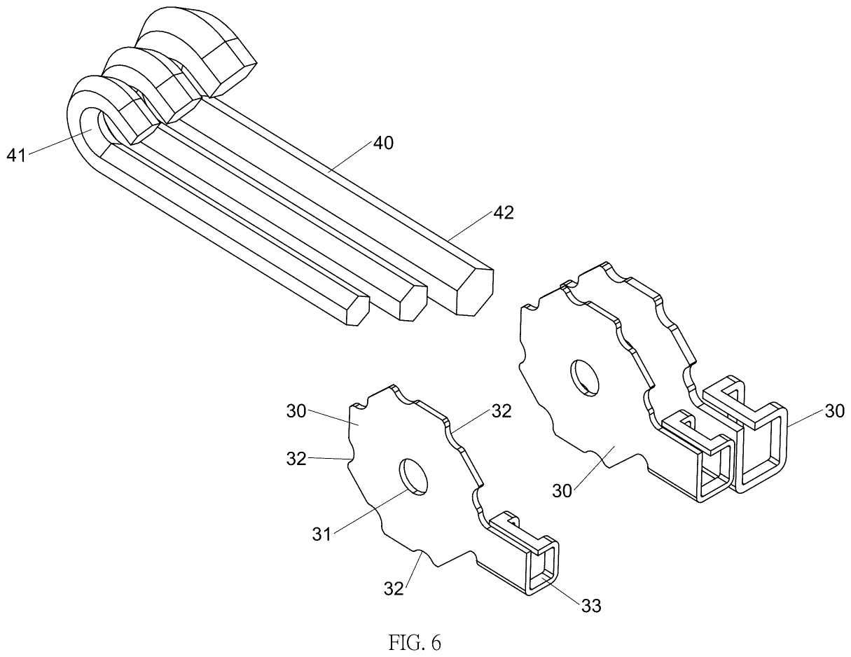

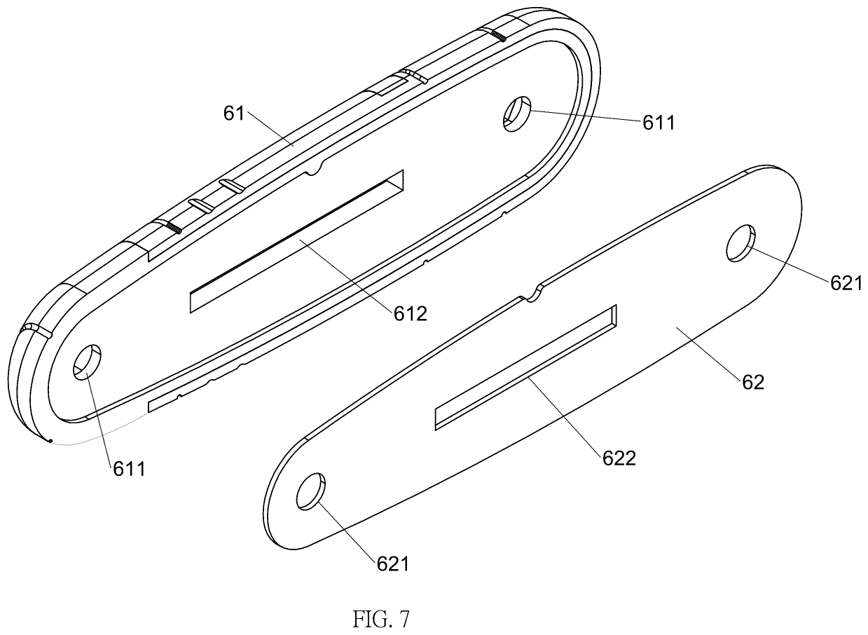

Referring to the drawings and initially to FIGS. 1-10, a tool assembly in accordance with the preferred embodiment of the present invention comprises a first body 10, two control units 20, multiple rotational members 30, multiple hand tools 40, two second body units 60, and two fastening members 70.

The first body 10 has two first pivot portions 11 provided on two ends thereof. Each of the two first pivot portions 11 has a circular through hole. Each of the two first pivot portions 11 is provided with multiple receiving spaces 12 arranged linearly. The first body 10 has two control chambers 13 provided on the two ends thereof. Each of the two control chambers 13 is a non-circular channel. The two control chambers 13 are disposed between the two first pivot portions 11. Each of the two control chambers 13 has a side provided with a first opening 131. The first opening 131 connects each of the two control chambers 13 to the receiving spaces 12. Each of the two control chambers 13 is provided with a second opening 132. The second opening 132 is an open slot. Each of the two control chambers 13 has a bottom provided with a second pivot portion 133. The second pivot portion 133 is a through hole. The second pivot portion 133 has an axis parallel with that of each of the two first pivot portions 11. The first body 10 has two projections 14 provided on two sides thereof. The two projections 14 are located between the two control chambers 13.

The two control units 20 are received in the two control chambers 13 respectively. Each of the two control units 20 is movable in one of the two control chambers 13. Each of the two control units 20 includes a control block 21 and two first elastic members 22.

The control block 21 is received in one of the two control chambers 13 and movable linearly in one of the two control chambers 13. The control block 21 has a shape matching that of each of the two control chambers 13. Preferably, the control block 21 has a non-circular shape. The control block 21 is provided with a support portion 210 having a lump shape. The support portion 210 has a side provided with a control part 211 received in thee the first opening 131. The control part 211 is a circular rod and provided with multiple first locking sections 2111 and multiple passages 2112. Each of the first locking sections 2111 has a side provided with one of the passages 2112. Each of the passages 2112 is a cavity. The first locking sections 2111 and the passages 2112 are arranged alternatingly and linearly. The first locking sections 2111 and the passages 2112 are directed toward the receiving spaces 12.

The control part 211 has a distal end provided with a pivoting section 2113 received in the second pivot portion 133. The pivoting section 2113 may extend into the second pivot portion 133 after the control block 21 is moved. The control block 21 has a side provided with two receiving recesses 212. Each of the two receiving recesses 212 has an opening directed toward the bottom of each of the two control chambers 13. Each of the two receiving recesses 212 has a circular shape and does not penetrate the control block 21. The control block 21 is provided with a drive portion 213 movably received in the second opening 132. The drive portion 213 protrudes from the second opening 132 and allows a user driving the control block 21 to move linearly.

The two first elastic members 22 are received in the two receiving recesses 212 respectively. Each of the two first elastic members 22 is biased between a bottom of each of the two receiving recesses 212 and the bottom of each of the two control chambers 13, so that the control block 21 has an elastically restoring effect.

Each of the rotational members 30 is pivotally mounted in each of the receiving spaces 12 and is rotatable in each of the receiving spaces 12. Each of the rotational members 30 is provided with a third pivot portion 31 aligning with one of the two first pivot portions 11. The third pivot portion 31 is a circular hole. Each of the rotational members 30 is provided with multiple second locking portions 32, with one of the second locking portions 32 aligning with the first opening 131. The second locking portions 32 are arranged annularly about an axis of the third pivot portion 31. Each of the second locking portions 32 is a concave groove. Each of the rotational members 30 has an end provided with a receiving groove 33. Preferably, the receiving groove 33 has a rectangular or hexagonal shape. Preferably, each of the rotational members 30 is a sheet plate, and the receiving groove 33 is formed by bending each of the rotational members 30.

Each of the hand tools 40 is mounted on each of the rotational members 30. Each of the hand tools 40 and each of the rotational members 30 are pivotally mounted in each of the receiving spaces 12. Each of the hand tools 40 and each of the rotational members 30 are rotated about one of the two first pivot portions 11 through an angle. Each of the hand tools 40 is provided with a fourth pivot portion 41 aligning with the third pivot portion 31 and one of the two first pivot portions 11. Each of the hand tools 40 is provided with an operation (or action) end 42 extending through and received in the receiving groove 33, so that each of the hand tools 40 is driven and rotated by each of the rotational members 30. Preferably, each of the hand tools 40 is a hex wrench having a 9-shaped profile.

Each of the two control units 20 is movable linearly in one of the two control chambers 13 and controls the rotational members 30 and the hand tools 40 to move relative to the first body 10 between a locked state and an unlocked state.

The two second body units 60 are mounted outside of the first body 10, with one of the two second body units 60 limiting the two control units 20 to prevent the two control units 20 from being detached from the two control chambers 13. The two second body units 60 are arranged symmetrically relative to the first body 10. Each of the two second body units 60 includes a second body 61 and a positioning member 62.

The second body 61 has two fifth pivot portions 611 provided on two ends thereof. Each of the two fifth pivot portions 611 aligns with one of the two first pivot portions 11, the third pivot portion 31, and the fourth pivot portion 41. The second body 61 has a middle provided with a first slot 612 aligning with and mounted on one of the two projections 14.

The positioning member 62 is a sheet plate. The positioning member 62 is combined with the second body 61 and assembled between the first body 10 and the second body 61. The positioning member 62 has two sixth pivot portions 621 provided on two ends thereof. Each of the two sixth pivot portions 621 aligns with one of the two first pivot portions 11, the third pivot portion 31, the fourth pivot portion 41, and one of the two fifth pivot portions 611. The positioning member 62 has a middle provided with a second slot 612 aligning with and mounted on one of the two projections 14. The second slot 612 aligns with the first slot 612.

Each of the two fastening members 70 extends through one of the two fifth pivot portions 611, one of the two sixth pivot portions 621, one of the two first pivot portions 11, the third pivot portion 31, and the fourth pivot portion 41, so that the first body 10, the rotational members 30, the hand tools 40, and the two second body units 60 are assembled. Preferably, each of the two fastening members 70 is a bolt, and two nuts are mounted in the two fifth pivot portions 611 of one of the two second body units 60 and screwed onto the two fastening members 70, so that the two second body units 60 are combined by the two fastening members 70 and the two nuts.

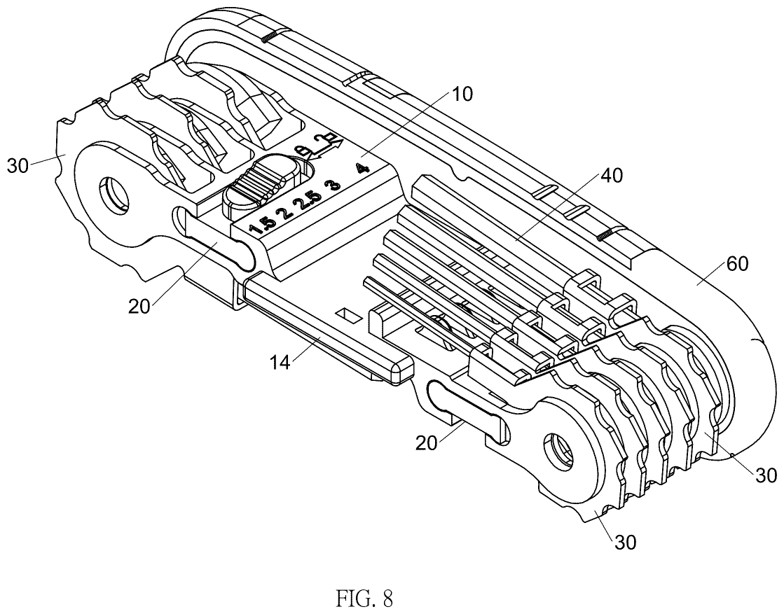

In assembly, referring to FIGS. 8 and 9 with reference to FIGS. 1-7, the two control units 20 are received in the two control chambers 13 respectively, with each of the two first elastic members 22 biased between the bottom of each of the two receiving recesses 212 and the bottom of each of the two control chambers 13, so that each of the two control units 20 can be restored elastically. Each of the hand tools 40 is mounted on each of the rotational members 30. Each of the hand tools 40 and each of the rotational members 30 are pivotally mounted in each of the receiving spaces 12. The two second body units 60 are mounted outside of the first body 10. Each of the two fastening members 70 extends through one of the two fifth pivot portions 611, one of the two sixth pivot portions 621, one of the two first pivot portions 11, the third pivot portion 31, and the fourth pivot portion 41, so that the first body 10, the rotational members 30, the hand tools 40, and the two second body units 60 are assembled.

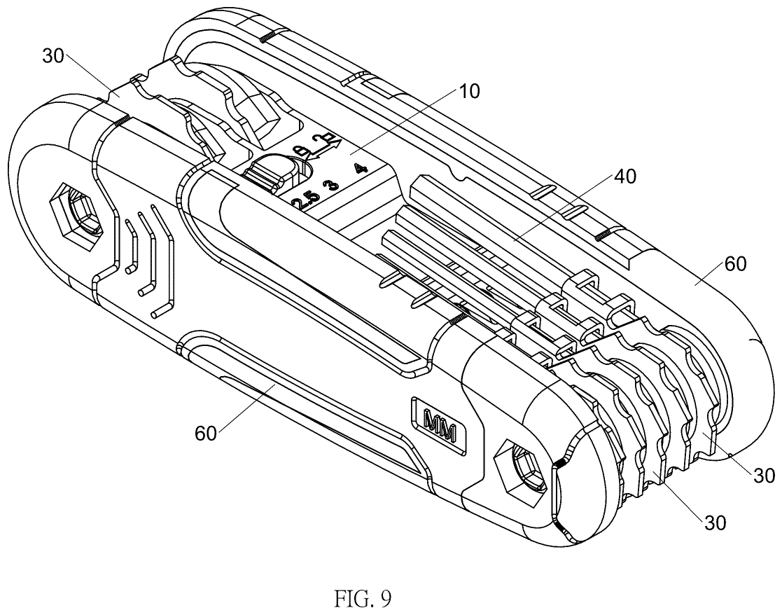

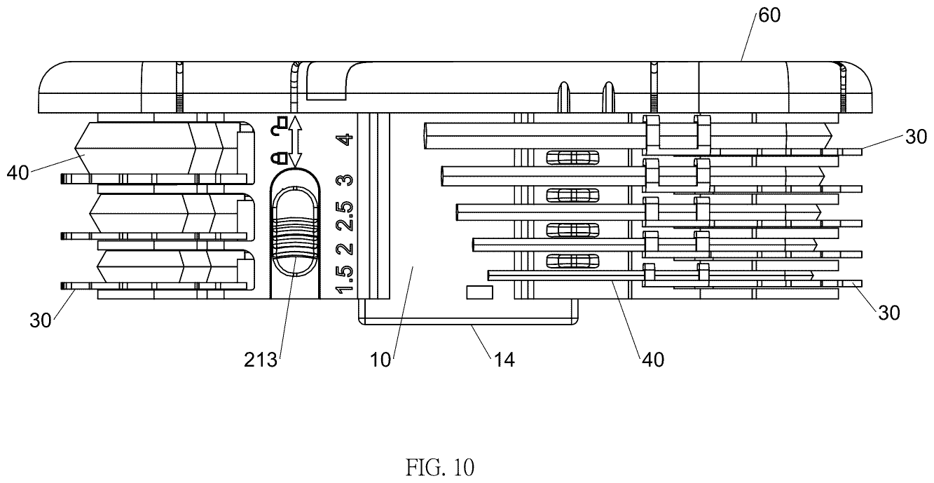

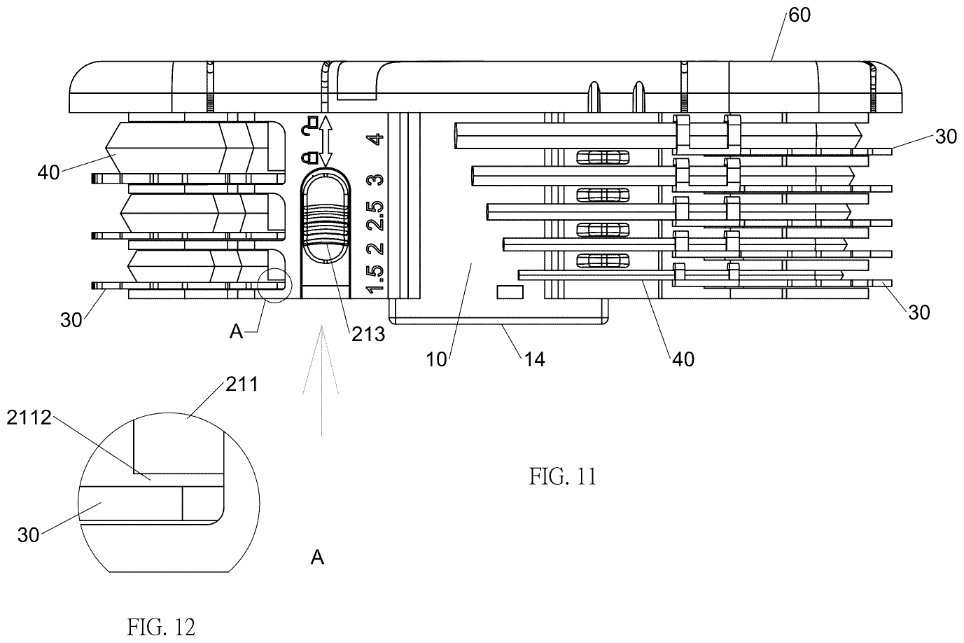

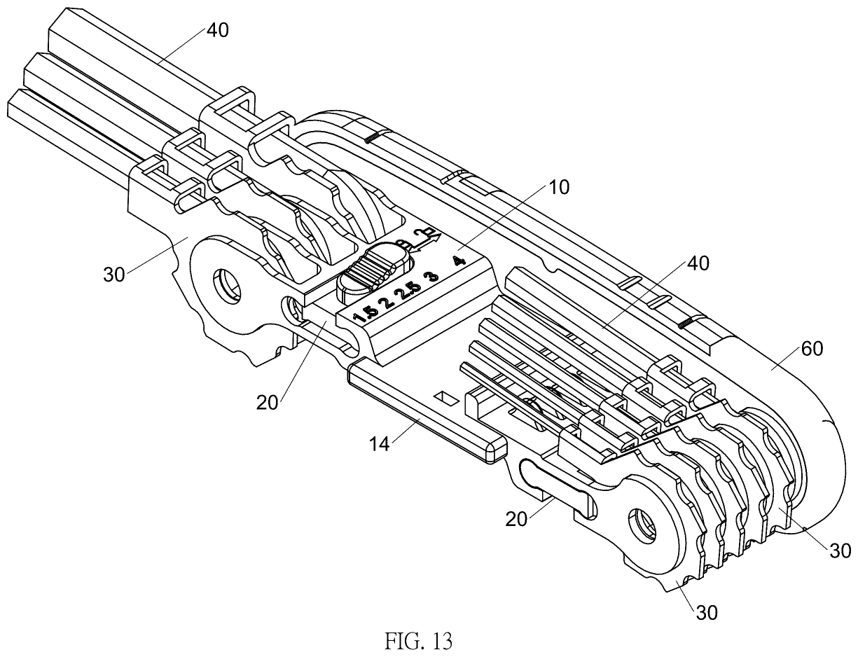

In operation, referring to FIGS. 10-13 with reference to FIGS. 1-9, when each of the two control units 20 is disposed at the locked state as shown in FIG. 10, one of the second locking portions 32 aligns with and is locked on one of the first locking sections 2111, and the rotational members 30 and the hand tools 40 are folded relative to the first body 10. When the drive portion 213 is driven, the control block 21 is moved linearly through a distance, the two first elastic members 22 are compressed by the control block 21, one of the passages 2112 is moved to align with one of the second locking portions 32, so that each of the two control units 20 is disposed at the unlocked state as shown in FIG. 11, and each of the hand tools 40 and each of the rotational members 30 are rotated about one of the two first pivot portions 11 and exposed from each of the receiving spaces 12. Thus, the second locking portions 32 of different positions are locked on one of the first locking sections 2111, so that the hand tools 40 are expanded relative to the first body 10 through different angles. In addition, the hand tools 40 are fully expanded relative to the first body 10 as shown in FIG. 13.

When each of the two control units 20 is released, the control block 21 is elastically pushed by the two first elastic members 22 to return to an original position, one of the first locking sections 2111 is moved to align with and is locked on one of the second locking portions 32, and the rotational members 30 and the hand tools 40 are fixed relative to the first body 10, so that each of the two control units 20 is disposed at the locked state.

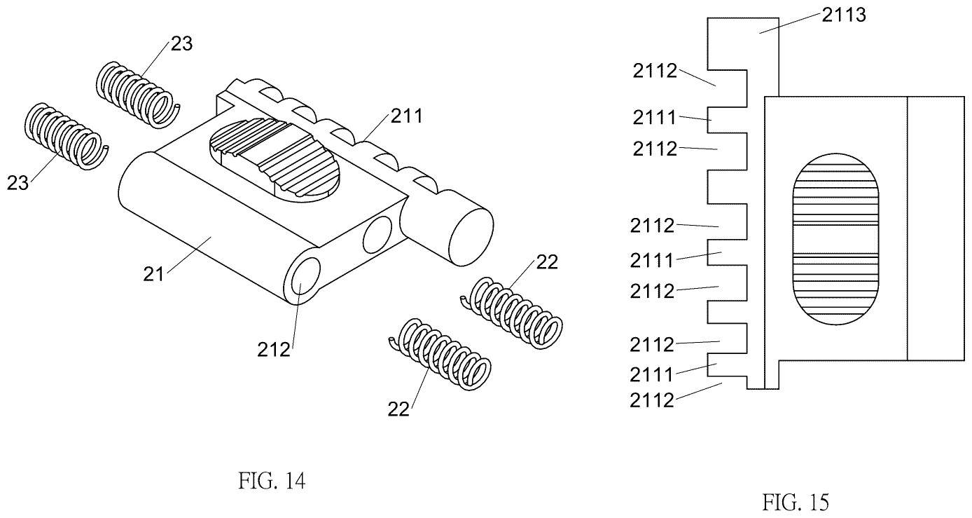

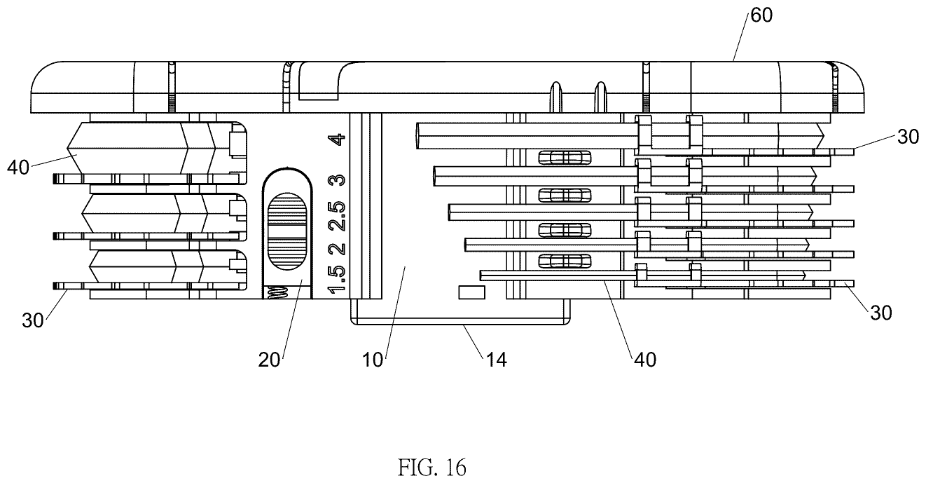

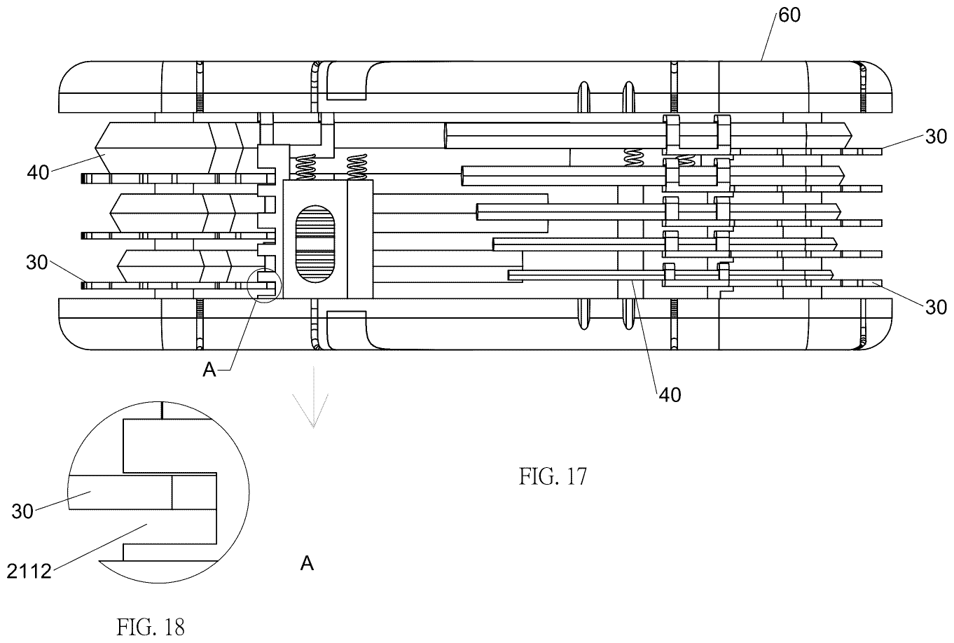

Referring to FIGS. 14-18, the control block 21 has two sides each of which is provided with the two receiving recesses 212. The two first elastic members 22 are received in the two receiving recesses 212 of one of the two sides of the control block 21, and each of the two control units 20 further includes two second elastic members 23 received in the two receiving recesses 212 of the other one of the two sides of the control block 21. Each of the two second elastic members 23 is biased between the bottom of each of the two receiving recesses 212 and one of the two second body units 60.

Each of the first locking sections 2111 of the control part 211 has two sides each of which is provided with one of the passages 2112. Thus, the control block 21 is driven in two directions between a first position where one of the first locking sections 2111 aligns with one of the second locking portions 32 so that each of the two control units 20 is disposed at the locked state, and a second position where one of the passages 2112 aligns with one of the second locking portions 32 so that each of the two control units 20 is disposed at the unlocked state.

Accordingly, the tool assembly of the present invention has the following advantages.
1. Each of the rotational members 30 and each of the hand tools 40 are rotatable in the first body 10. The operation end 42 of each of the hand tools 40 may be folded and stored in the first body 10 and has a locking effect. When the locked state is unlocked by the user, each of the hand tools 40 is rotated so that the operation end 42 of each of the hand tools 40 is exposed from the first body 10 to facilitate the user operating the hand tools 40. Thus, the hand tools 40 are operated, stored, and carried easily and conveniently.
2. The support portion 210 has a lump shape, and each of the passages 2112 is a cavity. Thus, each of the passages 2112 has a better structural support, so that the control block 21 has a better structural strength and is not broken easily.
3. The control part 211 is provided with the first locking sections 2111 and the passages 2112. The first locking sections 2111 and the passages 2112 are supported by the support portion 210, so that the first locking sections 2111 and the second locking portions 32 are locked exactly to secure the locked state. When one of the passages 2112 aligns with one of the second locking portions 32, the locked state is unlocked, so that the rotational members 30 and the hand tools 40 can be rotated freely relative to the first body 10.
4. The two second body units 60 are mounted outside of the first body 10, with one of the two second body units 60 limiting the two control units 20 to prevent the two control units 20 from being detached from the two control chambers 13. Each of the two control units 20 is used to lock or unlock the rotational members 30 and the hand tools 40, so that only a single element is needed to perform the locking or unlocking function.
5. Each of the two control units 20 is switched between the locked state and the unlocked state by pushing movement. The drive portion 213 protrudes from the top and the bottom of the first body 10 as shown in FIG. 8. The two first elastic members 22 and the two second elastic members 23 are mounted on the two sides of the control block 21 respectively, so that each of the two control units 20 may be driven from the two sides of the control block 21. Thus, when the user holds each of the two control units 20 in any one of the two directions, the drive portion 213 is touched by the user's thumb easily, to facilitate the user operating each of the two control units 20.
6. When the drive portion 213 is driven, one of the passages 2112 is moved to align with one of the second locking portions 32, so that each of the two control units 20 is disposed at the unlocked state as shown in FIG. 11, and each of the hand tools 40 and each of the rotational members 30 are rotated about one of the two first pivot portions 11 and exposed from each of the receiving spaces 12. Thus, each of the hand tools 40 and each of the rotational members 30 are rotated relative to the first body 10 to reach the required angle. When the drive portion 213 is released, the control block 21 is pushed by the two first elastic members 22 to return to the original position, and one of the first locking sections 2111 is again moved to align with and locked on one of the second locking portions 32, so that the rotational members 30 and the hand tools 40 are fixed relative to the first body 10 and disposed at the locked state. Thus, each of the two control units 20 is controlled by pushing to release the locked state, so that the user can operate each of the two control units 20 quickly and conveniently.
7. The first body 10 is provided with the second pivot portion 133, and the control part 211 of each of the two control units 20 is provided with the pivoting section 2113 pivotally mounted in the second pivot portion 133. When each of the two control units 20 is moved in one of the two control chambers 13 between the locked state and the unlocked state, the pivoting section 2113 and the second pivot portion 133 limit the maximum distance of movement, to prevent each of the two control units 20 from being moved excessively. Preferably, markings are provided outside of the second opening 132 to indicate the locked state and the unlocked state of the drive portion 213.
8. When the drive portion 213 is released, the control block 21 of each of the two control units 20 is pushed by the two first elastic members 22 to return to the original position, so that the unlocked state is switched to the locked state automatically, thereby facilitating the user operating each of the two control units 20.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A tool assembly comprising:
a first body, two control units, multiple rotational members, multiple hand tools, two second body units, and two fastening members;
wherein:
the first body has two first pivot portions provided on two ends thereof;
each of the two first pivot portions has a circular through hole;
each of the two first pivot portions is provided with multiple receiving spaces arranged linearly;
the first body has two control chambers provided on the two ends thereof;
each of the two control chambers is a non-circular channel;
the two control chambers are disposed between the two first pivot portions;
each of the two control chambers has a side provided with a first opening;
the first opening connects each of the two control chambers to the receiving spaces;
each of the two control chambers is provided with a second opening;
the second opening is an open slot;
each of the two control chambers has a bottom provided with a second pivot portion;
the second pivot portion is a through hole;
the second pivot portion has an axis parallel with that of each of the two first pivot portions;
the first body has two projections provided on two sides thereof;
the two projections are located between the two control chambers;
the two control units are received in the two control chambers respectively;
each of the two control units is movable in one of the two control chambers;
each of the two control units includes a control block and two first elastic members;
the control block is received in one of the two control chambers and movable linearly in one of the two control chambers;
the control block has a shape matching that of each of the two control chambers;
the control block has a non-circular shape;
the control block is provided with a support portion having a lump shape;
the support portion has a side provided with a control part received in thee the first opening;
the control part is a circular rod and provided with multiple first locking sections and multiple passages;
each of the first locking sections has a side provided with one of the passages;
each of the passages is a cavity;
the first locking sections and the passages are arranged alternatingly and linearly;
the first locking sections and the passages are directed toward the receiving spaces;
the control part has a distal end provided with a pivoting section received in the second pivot portion;
the pivoting section may extend into the second pivot portion after the control block is moved;
the control block has a side provided with two receiving recesses;
each of the two receiving recesses has an opening directed toward the bottom of each of the two control chambers;
the control block is provided with a drive portion movably received in the second opening;
the drive portion protrudes from the second opening and drives the control block to move linearly;
the two first elastic members are received in the two receiving recesses respectively;
each of the two first elastic members is biased between a bottom of each of the two receiving recesses and the bottom of each of the two control chambers, so that the control block has an elastically restoring effect;
each of the rotational members is pivotally mounted in each of the receiving spaces and is rotatable in each of the receiving spaces;
each of the rotational members is provided with a third pivot portion aligning with one of the two first pivot portions;
the third pivot portion is a circular hole;
each of the rotational members is provided with multiple second locking portions, with one of the second locking portions aligning with the first opening;
the second locking portions are arranged annularly about an axis of the third pivot portion;
each of the second locking portions is a concave groove;
each of the rotational members has an end provided with a receiving groove;
each of the hand tools is mounted on each of the rotational members;
each of the hand tools and each of the rotational members are pivotally mounted in each of the receiving spaces;
each of the hand tools and each of the rotational members are rotated about one of the two first pivot portions through an angle;
each of the hand tools is provided with a fourth pivot portion aligning with the third pivot portion and one of the two first pivot portions;
each of the hand tools is provided with an operation end extending through and received in the receiving groove, so that each of the hand tools is driven and rotated by each of the rotational members;
each of the two control units is movable linearly in one of the two control chambers and controls the rotational members and the hand tools to move relative to the first body between a locked state and an unlocked state;
when each of the two control units is disposed at the locked state, one of the second locking portions aligns with and is locked on one of the first locking sections, and the rotational members and the hand tools are folded relative to the first body;
when the drive portion is driven, the control block is moved linearly through a distance, the two first elastic members are compressed by the control block, one of the passages is moved to align with one of the second locking portions, so that each of the two control units is disposed at the unlocked state, and each of the hand tools and each of the rotational members are rotated about one of the two first pivot portions and exposed from each of the receiving spaces;
the second locking portions of different positions are locked on one of the first locking sections, so that the hand tools are expanded relative to the first body through different angles;
the two second body units are mounted outside of the first body, with one of the two second body units limiting the two control units to prevent the two control units from being detached from the two control chambers;
the two second body units are arranged symmetrically relative to the first body;
each of the two second body units includes a second body and a positioning member;
the second body has two fifth pivot portions provided on two ends thereof;
each of the two fifth pivot portions aligns with one of the two first pivot portions, the third pivot portion, and the fourth pivot portion;
the second body has a middle provided with a first slot aligning with and mounted on one of the two projections;
the positioning member is a sheet plate;
the positioning member is combined with the second body and assembled between the first body and the second body;
the positioning member has two sixth pivot portions provided on two ends thereof;
each of the two sixth pivot portions aligns with one of the two first pivot portions, the third pivot portion, the fourth pivot portion, and one of the two fifth pivot portions;
the positioning member has a middle provided with a second slot aligning with and mounted on one of the two projections;
the second slot aligns with the first slot; and
each of the two fastening members extends through one of the two fifth pivot portions, one of the two sixth pivot portions, one of the two first pivot portions, the third pivot portion, and the fourth pivot portion, so that the first body, the rotational members, the hand tools, and the two second body units are assembled.

2. The tool assembly as claimed in claim 1, wherein each of the two receiving recesses has a circular shape and does not penetrate the control block.

3. The tool assembly as claimed in claim 1, wherein the receiving groove has a rectangular or hexagonal shape.

4. The tool assembly as claimed in claim 1, wherein each of the rotational members is a sheet plate, and the receiving groove is formed by bending each of the rotational members.

5. The tool assembly as claimed in claim 1, wherein each of the hand tools is a hex wrench having a 9-shaped profile.

6. The tool assembly as claimed in claim 1, wherein each of the two fastening members is a bolt, and two nuts are mounted in the two fifth pivot portions of one of the two second body units and screwed onto the two fastening members, so that the two second body units are combined by the two fastening members and the two nuts.

7. The tool assembly as claimed in claim 1, wherein when each of the two control units is released, the control block is elastically pushed by the two first elastic members to return to an original position, one of the first locking sections is moved to align with and is locked on one of the second locking portions, and the rotational members and the hand tools are fixed relative to the first body, so that each of the two control units is disposed at the locked state.

8. The tool assembly as claimed in claim 1, wherein:
the control block has two sides each of which is provided with the two receiving recesses;
the two first elastic members are received in the two receiving recesses of one of the two sides of the control block;
each of the two control units further includes two second elastic members received in the two receiving recesses of the other one of the two sides of the control block;
each of the two second elastic members is biased between the bottom of each of the two receiving recesses and one of the two second body units;
each of the first locking sections of the control part has two sides each of which is provided with one of the passages; and
the control block is driven in two directions between a first position where one of the first locking sections aligns with one of the second locking portions so that each of the two control units is disposed at the locked state, and a second position where one of the passages aligns with one of the second locking portions so that each of the two control units is disposed at the unlocked state.
